(19) United States
(12) Patent Application Publication
(10) Pub. No.: US 2008/0316022 A1
(43) Pub. Date: Dec. 25, 2008

(54) Beacon Based Tracking Devices and Methods for Using Such

(75) Inventors: James J. Buck, Longmont, CO (US); Peter Sackschewsky, Lafayette, CO (US); Victor Rompa, Westminster, CO (US); Joseph P. Newell, Louisville, CO (US)

Correspondence Address: THE HAMILTON LAW FIRM PC, 8555 W. BELLEVIEW AVE., G21-139, LITTLETON, CO, 80123, US

(73) Assignee: BI Incorporated, Boulder, CO (US)

(21) Appl. No.: 12/041,746

(22) Filed: Mar. 4, 2008

Related U.S. Application Data
(60) Provisional application No. 60/908,182, filed on Mar. 26, 2007.

(51) Int. Cl. H04Q 7/00; G08B 23/00

(52) U.S. Cl. 340/539.13; 340/573.4

(57) ABSTRACT

Various embodiments of the present invention provide tracking devices and systems, and methods for using such. As one example, a method for locating a individual monitoring device is disclosed that includes determining a discard status of an individual monitoring device, identifying a location of the individual monitoring device, uploading the location of the individual monitoring device to a monitoring system via a wireless communication link, entering a low power state of the individual monitoring device, receiving a wake-up signal from a mobile transmitter, and transmitting a human identifiable location signal.

### CROSS REFERENCE TO RELATED APPLICATION

The present application claims priority to (i.e., is a non-provisional of) U.S. Pat. App. No. 60/908,182 entitled “Systems and Methods for Active Monitoring”, and filed Mar. 26, 2007 by Buck. The entirety of the aforementioned application is incorporated herein by reference for all purposes.

### BACKGROUND OF THE INVENTION

The present invention is related to tracking devices, and in particular to tracking devices capable of monitoring human subjects.

Large numbers of individuals are currently housed in prisons. This represents a significant cost to society both in terms of housing expense and wasted productivity. To address this concern, house arrest systems have been developed for use by less violent offenders. This allows the less violent offender to be monitored outside of a traditional prison system and allows the offender an opportunity to work and interact to at least some degree in society. The same approach is applied to paroled prisoners allowing for a monitored transition between a prison atmosphere and returning to society.

Turning to FIG. 1a, a block diagram depicts a prior art monitoring system 100 that relies on hardwired communications between a bracelet monitor 120 and central monitoring system 160 via a telephone jack 170 of plain old telephone service (POTS) 175. Bracelet monitor 120 is attached to a human subject 110 using a securing device 190. In operation, human subject 110 is typically required to move bracelet monitor 120 into a defined range of a base unit 145 that is connected to a telephone jack 170 using a telephone cord 147. The aforementioned RF range is typically short. Therefore, during prescribed periods of time, the location of human subject 110 can be known to central monitoring system 160. This functions to some degree as a surrogate to a visit with a parole officer or other monitoring individual. While such an approach provides some level of monitoring and security, it does not provide knowledge about the individual's whereabouts during interim periods. This may not provide enough monitoring and security for some individuals. Furthermore, the individual is required to be co-located with base unit 145. For some cases, such a limited range does not allow for the needed mobility to perform many jobs or involve a person in many other productive opportunities.

More advanced systems rely on global positioning system (GPS) location information and wireless communications to overcome the aforementioned limitations. Turning to FIG. 1b, a block diagram depicts another prior art monitoring system 155 that relies on GPS satellites 145, 146, and 147 and a GPS receiver within bracelet monitor 121 to identify human subject's 111 physical locations. A cellular communication system 150 provides for a link between bracelet monitor 121 and a central monitoring system 160 for periodically uploading data related to human subject's 111 movements.

GPS location receivers generally rely on a plurality of non-geostationary GPS satellites. Therefore, at various points in time different combinations of GPS satellites transmissions are received by GPS receivers. FIG. 1b depicts, as an example, bracelet monitor 121 receiving three wireless transmissions 130, 131, and 132 from GPS satellites 145, 146, and 147 respectively. Central monitoring system 160 is connected with bracelet monitor 121 via wireless communication links 133 and 138 of cellular communication system 150 as illustrated in FIG. 1b.

One serious drawback of the prior art monitoring system 155 illustrated in FIG. 1b is that GPS functionality is substantially and often completed undermined when human subject 111 goes indoors. To address this potential, it may be possible to rely on advanced forward link trilateration (AFLT) techniques using cellular communication system 150 and a cellular transceiver built within the bracelet monitor 121 to identify the location of human subject 111 when GPS is not available. However, two draw backs of AFLT are: a) AFLT is costly with cellular telephone companies charging incrementally each time an AFLT is performed; and b) there are at least some locations having permanent or intermittent insufficient cellular coverage, and therefore many locations and/or times wherein AFLT will not work.

Thus, for at least the aforementioned reasons, there exists a need in the art for more advanced approaches, devices and systems for location monitoring.

### BRIEF SUMMARY OF THE INVENTION

The present invention is related to tracking devices, and in particular to tracking devices capable of monitoring human subjects.

Various embodiments of the present invention provide methods for locating a individual monitoring device. Such methods include determining a discard status of an individual monitoring device, identifying a location of the individual monitoring device, and uploading the location of the individual monitoring device to a monitoring system via a wireless communication link. The individual monitoring device is placed in a low power state where it remains until it receives a wake-up signal from a mobile transmitter at which time it transmits a human identifiable location signal. In some instances of the aforementioned embodiments, determining the discard status includes identifying one or more status including, but not limited to, an indication of no motion from a motion sensor, an indication from a continuity sensor that the individual monitoring device was removed, and/or an indication from a proximity sensor that the individual monitoring device has been moved out of range of a monitored subject. In a particular instance of the aforementioned embodiments, the discard status includes identifying a combination of the following: an indication of no motion from a motion sensor, an indication from a continuity sensor that the individual monitoring device was removed, and an indication from a proximity sensor that the individual monitoring device has been moved out of range of a monitored subject.

In some instances of the aforementioned embodiments, identifying the location of the individual monitoring device includes obtaining a location fix from, for example, a GPS fix and/or an AFLT fix. In various embodiments of the present invention, entering the low power state includes turning off a location fix system and a transmission system of the individual monitoring device. In particular instances of the aforementioned embodiments, entering the low power state includes turning off all systems of the individual monitoring device except a wake-up receiver. In one or more instances of the aforementioned embodiments, the human identifiable signal includes an audible signal. Such an audible signal may be stand alone, or may be included with one or more other human identifiable signals such as, for example, a visual signal.

Various other embodiments of the present invention provide for some individual monitoring devices each containing one or more, and not limited to, a beacon based location fix system, a GPS based location fix system, and/or an AFLT based fix system. In particular instances of the aforementioned embodiments, individual monitoring devices contain all three mentioned location fix systems. In addition, some individual monitoring devices instances contain a location fix selector. The location fix selector is operable to select a location fix from one of the beacon based location fix system, the GPS based fix system, or the AFLT based fix system.

In some instances of the aforementioned embodiments, the beacon based location system includes a receiver tailored to receive the location of a fixed beacon via a wireless transmission link and to store the location of the fixed beacon as a location of the individual monitoring device. In some other instances of various embodiments, individual monitoring devices each also include a transmitter, wherein the transmitter can be operated to wirelessly transmit a location fix to a monitoring system via a wireless communication link.

In still further other instances of the aforementioned embodiments, some individual monitoring devices also each include a location fix tamper detector. The location fix tamper detector consists of none, one, or more than one of the following detectors, but is not limited to, a shield detector, and/or a GPS jamming detector.

In yet other instances of some embodiments, some individual monitoring devices each also include a discard detector. The discard detector consists of none, one, or more than one of the following, but is not limited to, a means for finding indication of no motion from a motion sensor, a means for finding indication from a continuity sensor that the individual monitoring device was removed from a monitored subject, and/or a means for finding indication from a proximity sensor that the individual monitoring device has been moved out of range of a monitored subject.

In some further other instances of various embodiments, some individual monitoring devices each also include a recovery system, wherein the recovery system includes a receiver able to receive and identify a signal from a mobile transmitter and able to sound an audible recovery signal. For still further other instances the recovery system is activated when at least one discard status indicator is received. The discard status indicator is selected from a group consisting of none, one, or more than one of the following, but is not limited to, a means for finding indication of no motion, the indication from a continuity sensor that the individual monitoring device was removed, or the indication from the proximity sensor that the individual monitoring device has been moved out of range of the monitored subject; and wherein the recovery system is operable to transition the individual monitoring device into a low power state upon receiving the discard status indicator.

Yet other embodiments of the present invention provide methods for identifying a location of a monitored individual. Such methods include providing an individual monitoring device, wherein the individual monitoring device includes a beacon based location fix system, a GPS based location fix system, and an AFLT based fix system, determining at least one available location method, and selecting and performing a preferred location method.

In some instances of these aforementioned embodiments, determining at least one available location method includes determining through use of the beacon based location fix system that a location beacon is in range, and wherein selecting and performing the preferred location method includes receiving the location of the location beacon as the location of the monitored individual. In further instances of these aforementioned embodiments, determining the at least one available location method includes determining through use of the beacon based location fix system that a location beacon is not in range, and through use of the GPS based location fix system that GPS is available, and wherein selecting and performing the preferred location method includes receiving GPS location as the location of the monitored individual. In yet further instances of these aforementioned embodiments, determining the at least one available location method includes determining through use of the beacon based location fix system that a location beacon is not in range, through use of the GPS based location fix system that GPS is not available, and wherein selecting and performing the preferred location method includes performing an AFLT fix using the AFLT based fix system. In some other instances of aforementioned embodiments, the methods further include performing a confidence analysis of a location of the monitored individual.

This summary provides only a general outline of some embodiments according to the present invention. Many other objects, features, advantages and other embodiments of the present invention will become more fully apparent from the following detailed description, the appended claims and the accompanying drawings and figures.

### BRIEF DESCRIPTION OF THE DRAWINGS

A further understanding of the various embodiments of the present invention may be realized by reference to the figures which are described in remaining portions of the specification. In the figures, similar reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1a is a block diagram of a prior art monitoring system relying on hardwired communications;

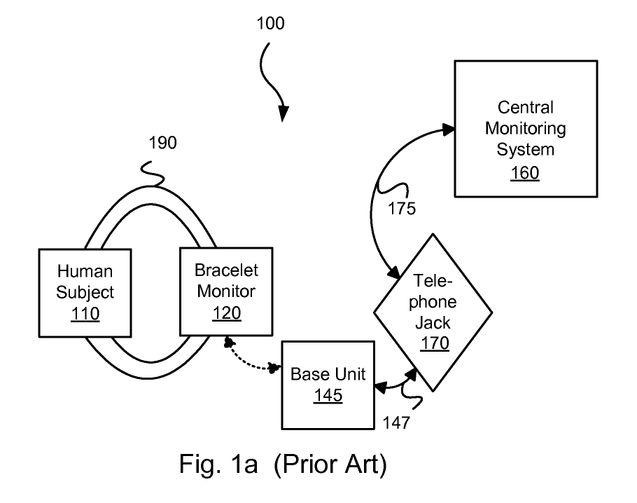

FIG. 1b is a block diagram of a prior art monitoring system relying on GPS positioning and cellular communications;

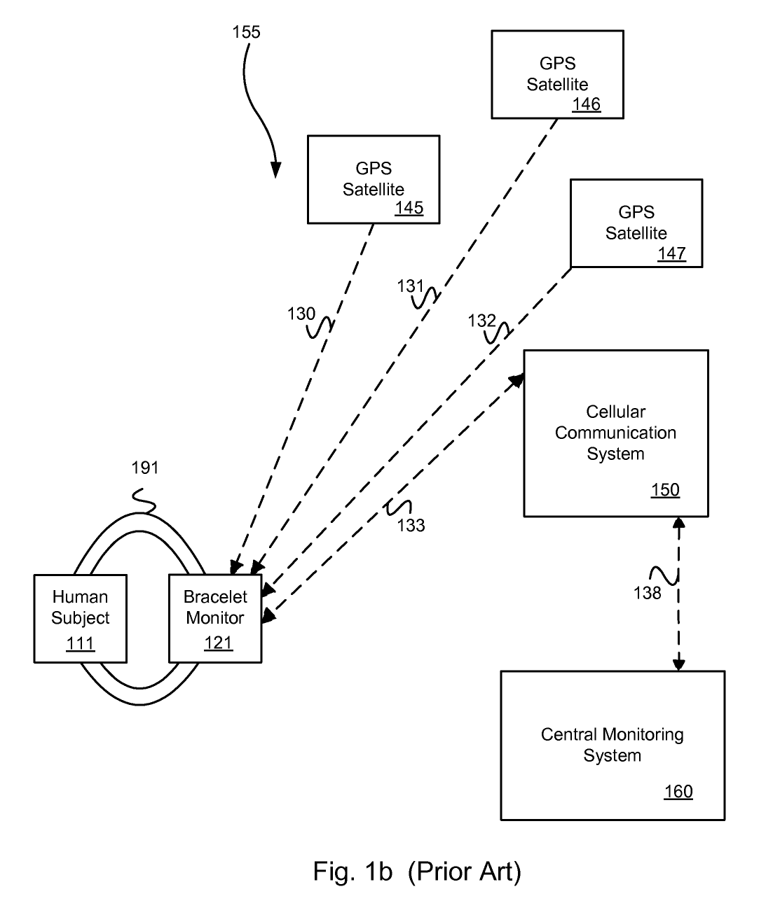

FIG. 2 is a block diagram illustrating a tracking and monitoring system in accordance with various embodiments of the present invention;

FIG. 3 depicts a tracking and monitoring system including a complex beacon accordance with some embodiments of the present invention;

FIG. 4 is a flow chart illustration of a method for placing and initializing a beacon in accordance with various embodiments of the present invention;

FIG. 5 is a flow diagram illustrating an operational process of a portable human tracking device in accordance with embodiments of the present invention;

FIG. 6 is a flow diagram illustrating an operational process of a portable tracking device when entering low power sleep mode, and responding to a locator beacon transmission in accordance with embodiments of the present invention;

FIG. 7 is a block diagram illustrating a tracking and monitoring system relying on simplified beacons in accordance with one or more embodiments of the present invention;

FIG. 8 depicts a tracking and monitoring system including a simplified beacon accordance with various embodiments of the present invention; and

FIG. 9 is a flow diagram illustrating an operational process of receiving beacon based information in place of location data in accordance with some embodiments of the present invention.

### DETAILED DESCRIPTION OF THE INVENTION

The present invention is related to tracking devices, and in particular to tracking devices capable of monitoring human subjects.

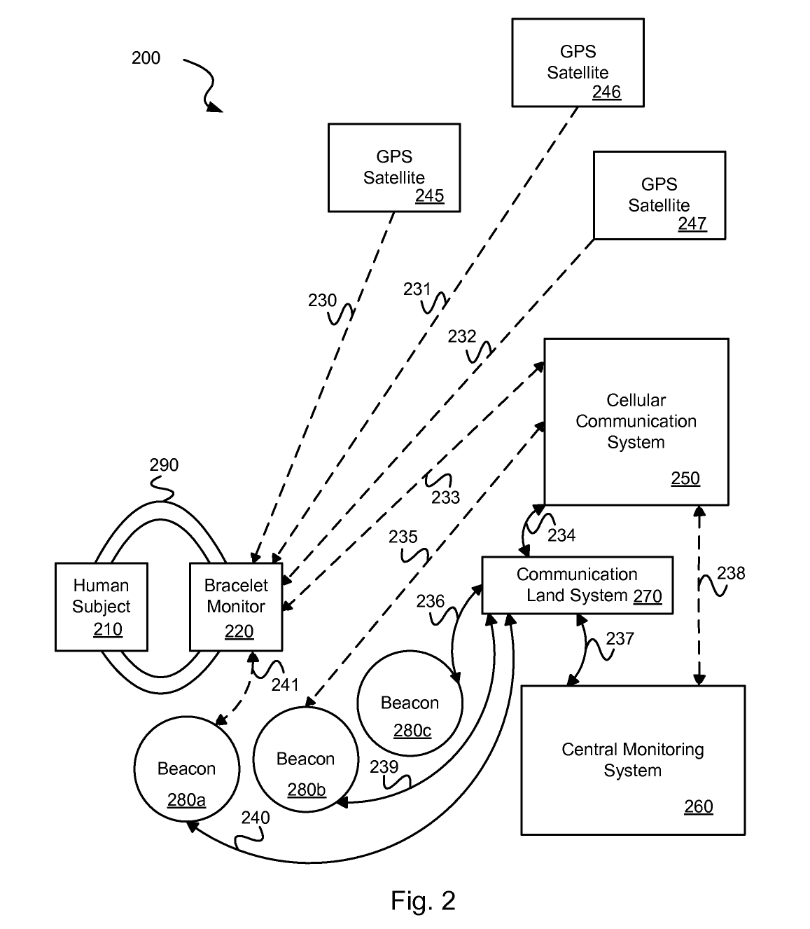

Turning to FIG. 2, a tracking and monitoring system 200 is depicted in accordance with various embodiments of the present invention. Tracking and monitoring system 200 may be tailored for tracking human subjects as is referred in this detailed description. However, it should be noted that various implementations and deployments of tracking and monitoring system 200 may be tailored for tracking other animals or even inanimate objects such as, for example, automobiles, boats, equipment, shipping containers or the like.

Tracking and monitoring system 200 includes, but is not limited to, a bracelet monitor 220 that is physically coupled to a human subject 210 by a securing device 290. In some cases, securing device 290 is a strap that includes a continuity sensor that when broken indicates an error or tamper condition. Further, in some cases, bracelet monitor 220 includes a proximity sensor that is able to detect when it has been moved away from an individual being monitored. When such movement away from the individual is detected, an error or tamper condition may be indicated. Based on the disclosure provided herein, one of ordinary skill in the art will recognize a variety of tamper sensors that may be incorporated in either bracelet monitor 220 or securing device 290 to allow for detection of removal of bracelet monitor 220 or other improper or unexpected meddling with bracelet monitor 220.

Bracelet monitor 220 is designed to provide the location of human subject 210 under a number of conditions. For example, when bracelet monitor 220 is capable of receiving wireless GPS location information 230, 231, 232 from a sufficient number of GPS satellites 245, 246, 247 respectively, bracelet monitor 220 may use the received wireless GPS location information to calculate or otherwise determine the location of human subject 210. Alternatively or in addition, the location of a beacon 280 that is local to bracelet monitor 220 may be used as the location of bracelet monitor 220. As yet another alternative, an AFLT fix may be established based on cellular communication with bracelet monitor 220. It should be noted that other types of earth based triangulation may be used in accordance with different embodiments of the present invention. For example, other cell phone based triangulation, UHF band triangulation such as Rosum, Wimax frequency based triangulation, S-5 based triangulation based on spread spectrum 900 MHz frequency signals. Based on the disclosure provided herein, one of ordinary skill in the art will recognize other types of earth based triangulation that may be used.

As yet another alternative, an AFLT fix may be established based on cellular communications between bracelet monitor 220 and a cellular communication system 250. Furthermore, when wireless communication link 233 between bracelet monitor 220 and cellular communications system 250 is periodically established, at those times, bracelet monitor 220 may report status and other stored records including location fixes to a central monitoring system 260 via wireless communication link 238.

Tracking and monitoring system 200 includes, but is not limited to, at least one beacon 280. Beacons 280 are instrumental for beacon based tracking and monitoring systems. Within FIG. 2, a telemetric wireless link 241 has been depicted between beacon 280a and bracelet monitor 220. Each beacon 280 has an adjustable range to make telemetric wireless contact with bracelet monitor 220. At any point in time, depending on each beacon's 280 relative distance to bracelet monitor 220, none, one, or more than one tracking beacons 280 may be within transmission range of a single bracelet monitor 220. Likewise, it is further conceivable under various circumstances that more than one bracelet monitor 220 at times be within in range of a solitary beacon 280.

Telemetric wireless communications path 241 established at times between tracking beacon 280a and bracelet monitor 220 illustrates a common feature of various different embodiments of the current invention. Some embodiments of the current invention vary on how, i.e. protocol, and what information and/or signaling is passed over wireless link 241. For example, in more simplified configurations and embodiments, each beacon 280 is limited to repetitively transmitting its own beacon ID and physical location information. In that way, once bracelet monitor 220 is within transmission range of tracking beacon 280a and establishes wireless or wired reception 241, then bracelet monitor 220 can record and store received beacon ID and location information. At a later time, for some embodiments of the present invention, bracelet monitor 220 can then report recorded readings from beacons 280 to the central monitoring system 260 over the cellular communication system 250 using wireless links 233 and 238 as depicted in FIG. 2. Furthermore, many embodiments allow for such transmissions and information passing to occur without being noticed by human subject 210, and unnoticed, automatically, and near effortlessly central monitoring system 260 is able to establish records and track human subject's 210 movements and whereabouts.

In other embodiments or configurations according to the present invention, each beacon 280 also transmit status information related to its own device health and information related from each beacon's 280 internal tampering, movement, or other sensors via a communication system 270 to central monitoring system 260. This allows for detection of movement of beacons 280, and establishing some level of confidence that the location reported by each of beacons 280 is accurate.

Likewise, in some other embodiments, each bracelet monitor 220 contains a host of their own tampering, shielding, movement, and/or other sensors related to its own device health. While still further embodiments also include a host of other measurement transducers within bracelet monitor 220 for extracting information, and for later reporting, related to physical properties of human subject 210. For example, measuring for the presence of alcohol and/or other drugs present in human subject 210 may be included in some embodiments of bracelet monitor 220. As one example, the alcohol sensor discussed in U.S. patent application Ser. No. ______(Attorney Docket No. BI-000610) entitled “Transdermal Portable Alcohol Monitor and Methods for Using Such” and filed by Cooper et al. on a date even herewith. The entirety of the aforementioned application is incorporated herein by reference for all purposes.

Beacons 280 in alternative embodiments of the present invention also communicate with central monitoring system 260 independently of bracelet monitor 220. The tracking and monitoring system 200 illustrated in FIG. 2 shows beacon 280b having both a wireless communication link 235 with cellular communication system 250, and also illustrates beacon 280b having a hardwired communication link 239 with land communication system 270. Tracking and monitoring system 200 is also shown with beacons 280a, 280b, and 280c each having hardwired land communication links 240, 239, and 236 respectively to land communication system 270. Tracking and monitoring system 200 further illustrates land communication system 270 having a hardwired communication link 234 to cellular communication system 250, and a hardwired communication link 237 to central monitoring system 260.

In some embodiments of the present invention, beacons 280 are located in areas frequented by human subject 210 where bracelet monitor 220 is incapable of accessing information from the GPS system. Such beacons eliminate the need to perform an AFLT fix and avoid the costs associated therewith. As an example, human subject 210 may have a tracking beacon 280 placed within his home, and one also placed at his place of employment in close proximity to his work area. In this way, the two placed beacons, each at different prescribed times, can interact with his attached bracelet monitor 220 to periodically make reports to central monitoring system 260 to track movements and the whereabouts of human subject 210. All this can be done without incurring the costs associated with performing an AFLT fix.

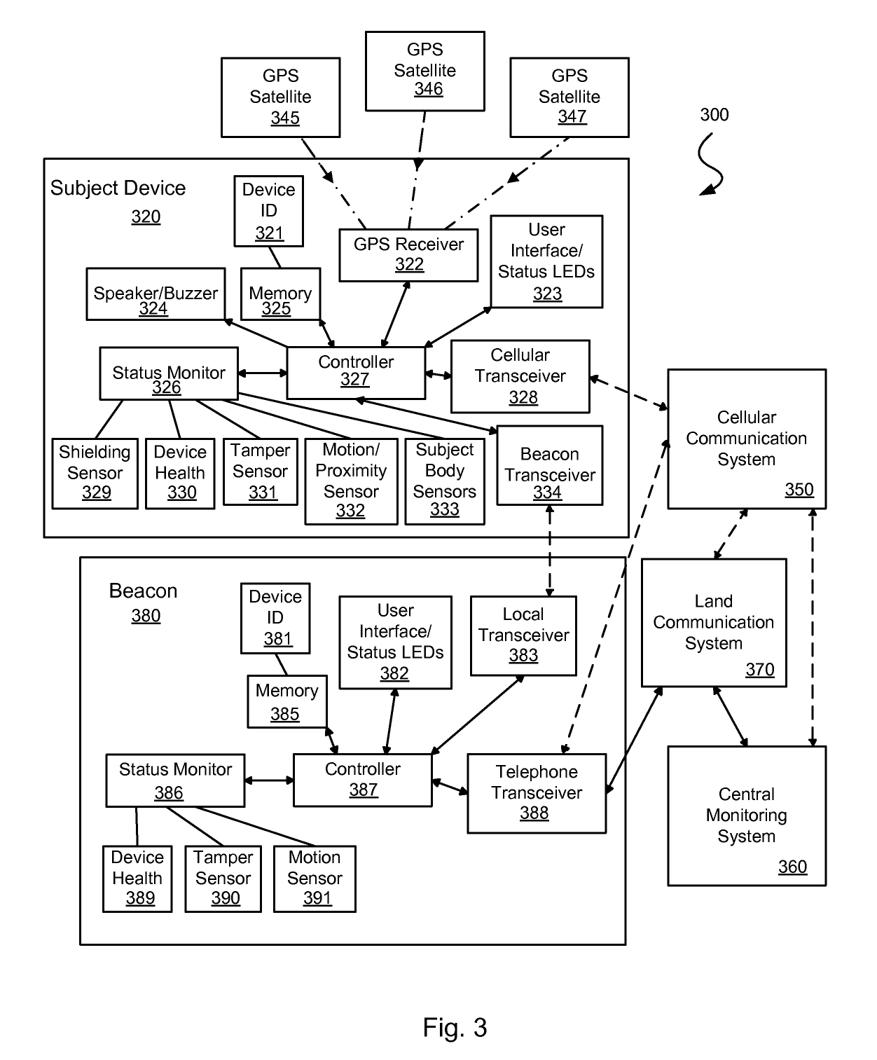

Turning to FIG. 3, a tracking and monitoring system 300 is depicted in accordance with some embodiments of the present invention. As shown in FIG. 3, tracking and monitoring system 300 includes only a single beacon 380 in communication with a subject device 320 (e.g., a monitoring bracelet). Subject device 320 is similar to or in some instances can be considered identical to a bracelet monitor 220 of FIG. 2. Also, similar to bracelet monitor 220, subject device 320 is capable of receiving GPS information from GPS satellites 345, 346, and 347 respectively. A GPS receiver 322 within subject device 320 at times is useful for determining physical locations, i.e. whenever GPS receiver 322 is powered-on, and also as long as receiving sufficient GPS satellites signal transmissions.

Tracking and monitoring system 300 illustrates subject device's 320 device ID 321 being stored in a memory 325, and is thus accessible by a controller 327. Controller 327 is able to interact with GPS receiver 322 and memory 325 at times for storing and generating records of successively determined GPS locations. Controller 327 may be, but is not limited to, a microprocessor, microcontroller or other device known in the art that is capable of executing software or firmware instructions.

Controller 327 of subject device 320 at times functions in conjunction with a cellular transceiver 328 to send and receive data and signals through cellular communication system 350. This link at times is useful for passing information and/or control signals between central monitoring system 360 and subject device 320. Cellular communication system 350 and cellular transceiver 328 can also at times often be useful for determining a physical location for subject devices 320 through AFLT when requested.

Tracking and monitoring system 300 depicts controller 327 interacting with a beacon transceiver 334. A status monitor 326, a user interface 323, and a speaker/buzzer 324 are all interconnected and interact through controller 327. In alternative embodiments of the present invention, status monitor 326 includes one or more of the following subcomponents: a set of shielding sensors 329 that are capable of determining whether subject device is being shielded from receiving GPS signals and/or if GPS jamming is ongoing, a set of device health indicators 330, a tamper sensor 331 capable of determining whether unauthorized access to subject device 320 has occurred or whether subject device 320 has been removed from an associated human subject, a motion/proximity sensor 332 capable of determining whether subject device 320 is moving and/or whether it is within proximity of human subject 210, and/or other body sensors 333 for making physical measurements of human subject 210. Based on the disclosure provided herein, one of ordinary skill in the art will recognize a variety of shielding sensors, a variety of device health transducers and indicators, a variety of tamper sensors, various different types of motion sensors, different proximity to human sensors, and various human body physical measurement sensors or transducers that may be incorporated into subject device 320 according to various different instances and/or embodiments of the present invention.

Beacon 380 includes a local transceiver 383 capable of providing information to subject device 320, and in some cases receiving information from subject device 320. Communication between beacon transceiver 334 and local transceiver 383 can be either wireless or wired. For example, the communication may be made via Universal Serial Bus protocol over a wired interface. Based on the disclosure provided herein, one of ordinary skill in the art will recognize a variety of wireless and wired interfaces and interface protocols that may be used in relation to different embodiments of the present invention. Beacon 380 further includes a device ID 381 maintained in a memory 385. Device ID 381 uniquely identifies beacon 380, and may in some cases be used to designate an operational difference between beacons (e.g., a beacon used to provide location information to a subject device or a beacon used to find a misplaced or discarded subject device). Beacon 380 may further include a user interface 382 that provides some indication of the operational status of the beacon.

In some instances, beacon 380 includes a telephone transceiver 388 that is capable of communication via one or both of a land communication system 370 or cellular communication system 350. Beacon 380 may also include a status monitor 386 that is capable of accessing information from device health sensors 389, tamper sensors 390 and/or motion sensors 391. Based on the disclosure provided herein, one of ordinary skill in the art will recognize a variety of status information that may be monitored to determine whether beacon 380 is properly operational and whether the location information provided from beacon 380 to subject device 320 is reliable. The various functional elements of beacon 380 are controlled by a controller 387 that may be, but is not limited to, microprocessor, microcontroller or other device known in the art that is capable of executing software or firmware instructions.

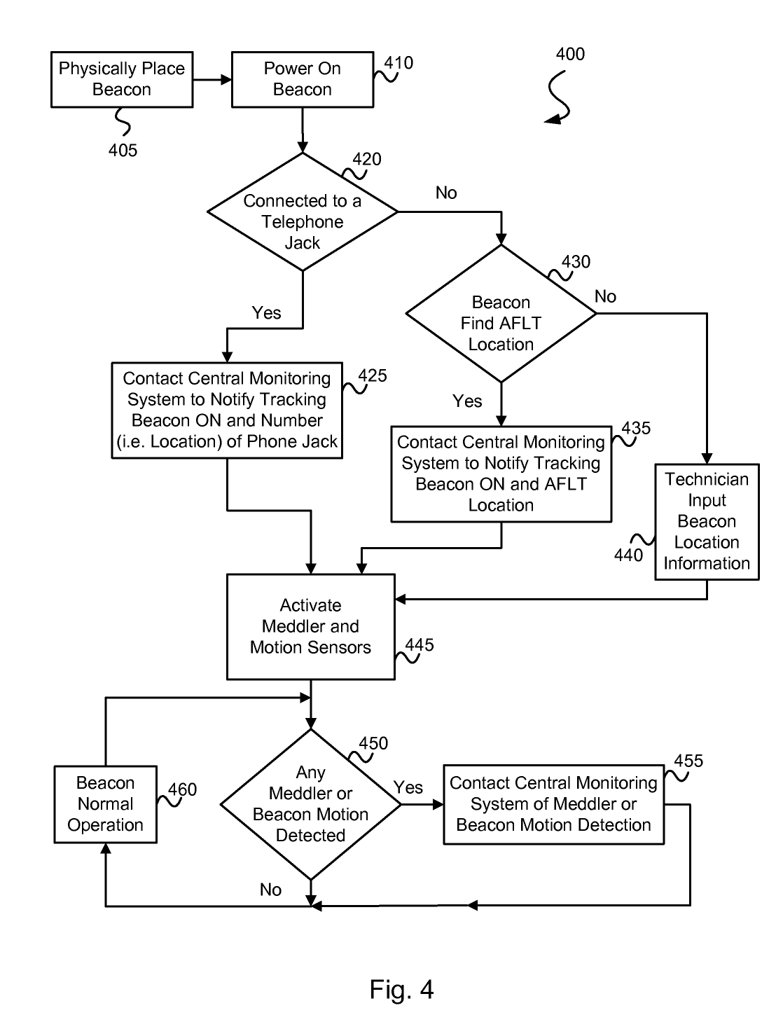

Turning to FIG. 4, a flow diagram 400 illustrates a method for beacon initialization and operation in accordance with some embodiments of the present invention. It should be noted that while flow diagram 400 is discussed in relation to the elements of FIG. 2 and FIG. 3, the methods may be applied to different embodiments of the present invention. Initially, beacon 380 is placed at a desired physical location (block 405) and powered on (block 410). In some cases, physical placement may be carried out by a parole officer or trusted technician, while in other cases it may be carried out by human subject 210. In some cases, beacon 380 is internally powered by, for example, a battery system. In other cases, beacon 380 is connected to an electrical outlet. In particular cases, beacon 380 includes a rechargeable battery system that may be connected to an electrical outlet. Based on the disclosure provided herein, one of ordinary skill in the art will recognize a variety of methods for powering such devices.

Once beacon 380 is deployed and powered on (blocks 405, 410), the location of beacon 380 is defined. The process of defining the location of beacon 380 may include use of one or more location processes either separately or in combination. Such location processes may include, but are not limited to, physical connection to a telephone jack at a known location, use of AFLT to identify the location of the beacon, and/or having a technician or authorized installer input beacon location information. In one particular embodiment, beacon 380 is relatively simple and allows only for the input of location information by an installer. In other cases, a more complex design is provided that allows for identifying the location of beacon 380 in one of an automatically selected way. Such an approach is set forth in block 420 through block 460 of flow diagram 400.

Following flow diagram 400, it is determined whether beacon 380 is connected to a telephone wall jack of POTS. If beacon 380 is communicably coupled to a central monitoring system 360 via a POTS telephone jack (block 420), central monitoring system 360 is contacted by beacon 380 and beacon 380 provides its unique identification and central monitoring system 360 uses the POTS telephone jack information to establish the location of beacon 380 and reports the location information to beacon 380 (block 425). Beacon 380 maintains the location of the POTS telephone jack as its location.

Following flow diagram 400, if beacon 380 is not communicably coupled via POTS, beacon 380 attempts an AFLT location fix (block 430). If the AFLT (block 430) is successful, beacon 380 uses cellular communications system to be communicably coupled with central monitoring system 360 to signify beacon's 380 on operational status, and to download the beacon location information generated by AFLT (block 435). Beacon 380 maintains the AFLT location information as its location. If the AFLT (block 430) is not successful, then a technician or other trusted individual as mentioned earlier manually inputs the beacon location information into the beacon 380 (block 440).

After the beacon location information has been identified and loaded (blocks 425, 435, and 440), a set of meddler and motion detection sensors within the beacon 380 are activated (block 445). In this way, once a beacon has been placed and initialized with its location information determined and stored, the set of meddler and motion detection sensors can determine if the beacon at a later time has been tampered with or moved. Therefore, periodically checking the set of meddler and motion detection sensors (block 450) to see if one or more have been tripped or activated indicating detection of tampering or movement of the placed and initialized beacon 380 is repetitively done.

If nothing abnormal is detected about tracking beacon 380, then beacon 380 performs its normal operation (block 460) including making transmissions and/or handshaking with bracelet monitor(s) within telemetric proximity and range. If, however, one or more of a beacon's 380 internal sensors indicates something abnormal due to a beacon malfunction, tampering, or movement, then central monitoring system 360 is notified of the error condition (block 455). Notification of the error condition may be accomplished by sending a message to central monitoring system 360. In other cases, there is no communication ability directly with central monitoring system 360. In such cases, the detected tamper (block 450) causes beacon 380 not to transmit its location information forcing subject device 320 to rely on an AFLT fix to determine its location.

FIG. 4 is presented for illustrative purposes according to some embodiments of the current invention. Various alternative embodiments have distinctive variations in the flow diagrams for methods of initialization and operation of a beacon 380. For example, in another embodiment, blocks 460, 450, and 455 all collapse into a single block, wherein there is not much actual difference in the operation of a beacon once an error condition or sensor has been tripped. For these embodiments, reporting the status of all internal sensors and measurements is standard and is customarily done along with reporting if any bracelet monitor(s) 220 have telemetrically been in wireless contact and/or communication with a beacon 380.

In some cases, the methods of Flow diagram 400 are implemented using software maintained on one or both of memory 325 and memory 385, and executed by respective controller 327 and controller 387.

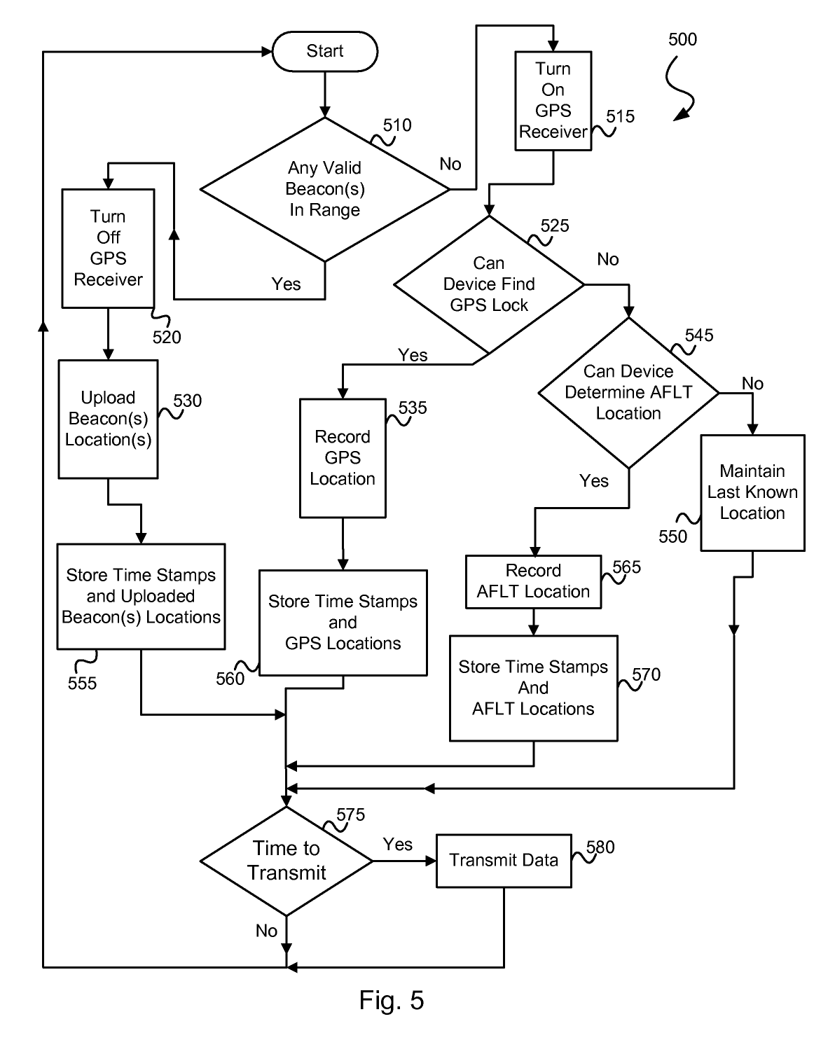

Turning to FIG. 5, a flow diagram 500 illustrates operation of bracelet monitor 220 (or subject device 320) in accordance with some embodiments of the present invention. The terminology of bracelet monitor 220 and/or subject device 320 can be, and are, interchangeable throughout this detailed description. Following flow diagram 500, it is first determined whether there is a beacon in range (block 510). This may include listening via beacon transceiver 334 for beacon related information that is being transmitted. Where a beacon is identified (block 510), the GPS receiver of the monitoring device is turned off to save power (block 520), and location information from the identified beacon is uploaded to subject device 320 (block 520). This process may include receiving location information from beacon 380 via beacon transceiver 334, and that location information is decoded by controller 327 and stored to memory 325. This location information may be maintained in memory 385 in relation to a time stamp (block 555). The location information and associated time stamp may then be made available to central monitoring system 360 using whatever method of communication is available to subject device 320 (blocks 575, 580).

Alternatively, where it is determined that a beacon is not in range (block 510), the GPS receiver is turned on to determine if GPS information is available (blocks 515, 525). Where a GPS lock is possible (block 525), the available GPS information is used to calculate the location of the monitoring device (e.g., subject device 320) and the location is recorded to the memory (block 535). This location information may be maintained in memory 385 in relation to a time stamp (block 560). The location information and associated time stamp may then be made available to central monitoring system 360 using whatever method of communication is available to subject device 320 (blocks 575, 580).

Alternatively, where a GPS lock is not possible (block 525), it is determined whether an AFLT fix is possible (block 545). Where an AFLT fix is possible (block 545) location information is identified using an AFLT fix (block 565). This location information may be maintained in memory 385 in relation to a time stamp (block 570). The location information and associated time stamp may then be made available to central monitoring system 360 using whatever method of communication is available to subject device 320 (blocks 575, 580). Alternatively, where it is determined that an AFLT fix is not possible (block 545), the last known location is maintained (block 550).

In some embodiments of the present invention, the processes of flow diagram 500 may be augmented to provide a confidence factor associated with the reported location. Thus, for example, where the location information is derived from the GPS system, it may be that the location information is reported along with an indication of the strength of the GPS signal used to calculate the location. This confidence information may be used to limit the reporting of questionable location information. For example, it may be that subject device 320 includes internal instructions that only provide for transmitting location information when the location is outside of a prescribed geographic boundary. In such a case, an out of boundary location derived from questionable GPS data may be ignored. In one particular embodiment of the present invention, a confidence factor may be programmed into subject device from central monitoring system 360 after subject device 320 has been deployed. Alternatively, confidence factors may be used at the central monitoring system to control, rather than on the subject device. This allows for adjusting the confidence factor in the event, for example, that a number of spurious location indicators are received and the confidence factor may be adjusted to avoid the reporting of such spurious results.

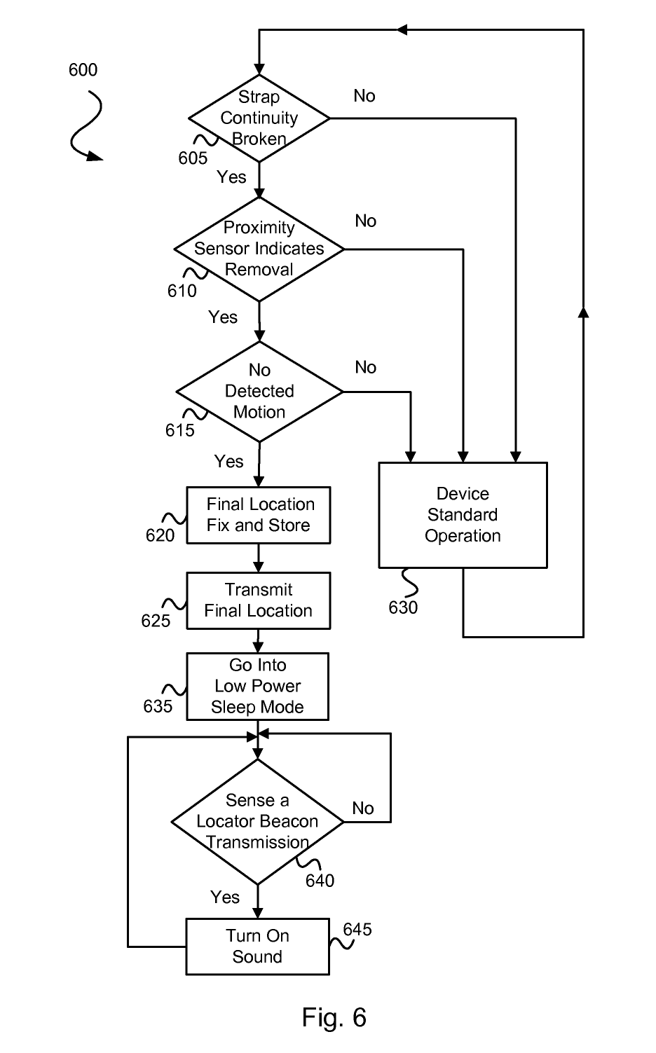

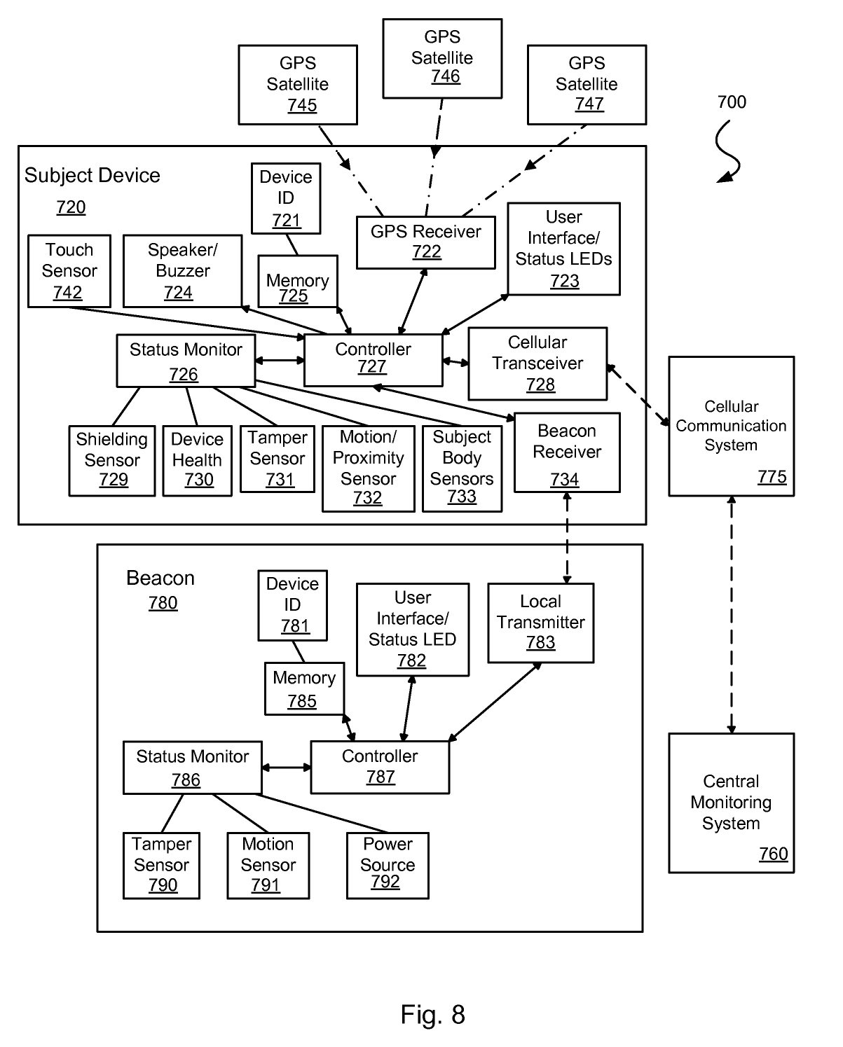

Turning to FIG. 6, a flow diagram 600 illustrates an operational process of a portable tracking device when entering low power sleep mode, and responding to a locator beacon transmission in accordance with embodiments of the present invention. Following flow diagram 600, it is determined whether strap continuity is broken (block 605), whether the proximity sensor indicates the subject device has been removed (block 610), and whether no motion is ongoing (block 615). This information can be gathered through one or more of tamper sensor 331 and motion/proximity sensor 332. Where any of the three conditions is not met (blocks 605, 610, 615), it is assumed that subject device 320 is still operational and associated with a human subject. In such a case, standard operation of subject device 320 is maintained. In other cases, it may be that a subset of the conditions are used to trigger the power savings condition. For example, maybe a combination of no detected motion and strap continuity without the proximity sensor occurring. Based on the disclosure provided herein, one of ordinary skill in the art will recognize a variety of combinations of sensor indications that may be used to indicate the power savings condition.

Where all three conditions are met (blocks 605, 610, 615), a final location fix is determined (block 620). This may be done either by communication with a local beacon, through use of GPS information or using an AFLT fix. This final location information is transmitted to central monitoring system 360 (block 625), and the device is placed in a low power mode (block 635). The low power mode preserves the battery of subject device 320. In some embodiments of the present invention, power is only maintained for beacon transceiver 334 that is capable of receiving a transmission from a beacon. When a beacon transmission is sensed (block 640), power is restored to subject device 320 and an audible alarm is sounded (block 645). This audible alarm continues until it is either manually disabled or until the battery of subject device 320 dies. The alarm may be manually disabled by, for example, a touch sensor discussed in relation to FIG. 8 below. Such an approach allows for a determination of a last known location of subject device 320 before it is discarded. This last known location can be used to bring a transmitter in range at which time an audible sound emitted by subject device 320 aids the searcher in locating the discarded subject device.

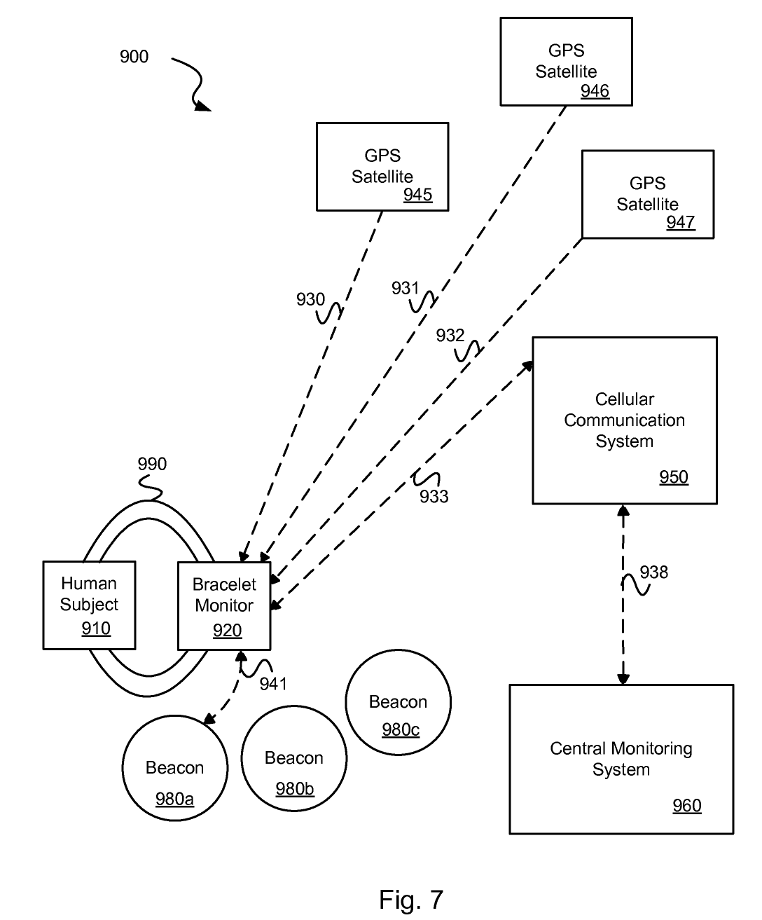

Turning to FIG. 7, a tracking and monitoring system 900 is depicted in accordance with various embodiments of the present invention. Tracking and monitoring system 900 relies on simplified beacons 980 that include capability for transmitting device ID information, power status information, motion information and case tamper information. Such beacons are very inexpensive to implement, but do not include all of the features of beacon 280 or beacon 380 discussed above. Tracking and monitoring system 900 includes, but is not limited to, a bracelet monitor 920 that is physically coupled to a human subject 910 by a securing device 990. In some cases, securing device 990 is a strap that includes a continuity sensor that when broken indicates an error or tamper condition. Further, in some cases, bracelet monitor 920 includes a proximity sensor that is able to detect when it has been moved away from an individual being monitored. When such movement away from the individual is detected, an error or tamper condition may be indicated. Based on the disclosure provided herein, one of ordinary skill in the art will recognize a variety of tamper sensors that may be incorporated in either bracelet monitor 920 or securing device 990 to allow for detection of removal of bracelet monitor 20 or other improper or unexpected meddling with bracelet monitor 920.

Bracelet monitor 920 is designed to provide the location of human subject 910 under a number of conditions. For example, when bracelet monitor 920 is capable of receiving wireless GPS location information 930, 931, 932 from a sufficient number of GPS satellites 945, 946, 947 respectively, bracelet monitor 920 may use the received wireless GPS location information to calculate or otherwise determine the location of human subject 910. Alternatively or in addition, the device ID of beacon 980 that is local to bracelet monitor 920 may be used as a proxy for the location of bracelet monitor 920. As yet another alternative, an AFLT fix may be established based on cellular communication (indicated as a dashed line 933) with bracelet monitor 920. Such an AFLT fix may be achieved, as is known in the art, by relying on three or more cell towers of a cellular communication system to perform a triangulation

Tracking and monitoring system 900 includes, but is not limited to, one or more beacons 980. Such beacons continuously transmit a beacon ID (indicated as a dashed line 241) that is registered with a central monitoring system 960 along with a known location of the particular beacon. When received, central monitoring system 960 uses the beacon ID to determine the location of bracelet monitor 920 that received the beacon ID and uploaded the beacon ID to central monitoring system (indicated by a dashed line 933 and a dashed line 938).

In some cases, beacons 980 include tamper detection circuitry such as, for example, a motion detector and a case tamper detector. When a beacon is moved or otherwise tampered with, it is declared unreliable and stops transmitting its beacon ID until it is reset. When the beacon stops transmitting its ID, bracelet monitor 920 cannot rely on it as a location proxy and must perform a more expensive AFLT fix to establish location. In other embodiment, a beacon that has been tampered with continues to transmit its ID, but also transmits the gathered tamper information. In this way, central monitoring system 960 may make a determination as to whether it will rely on the location information being received from bracelet monitor 920 that is transmitting the ID of the compromised beacon.

In some embodiments of the present invention, beacons 980 are located in areas frequented by human subject 910 where bracelet monitor 920 is incapable of accessing information from the GPS system. Such beacons eliminate the need to perform an AFLT fix and avoid the costs associated therewith. As an example, human subject 210 may have a tracking beacon 280 placed within his home, and one also placed at his place of employment in close proximity to his work area. In this way, the two placed beacons, each at different prescribed times, can interact with his attached bracelet monitor 220 to periodically make reports to central monitoring system 260 to track movements and the whereabouts of human subject 210. All this can be done without incurring the costs associated with performing an AFLT fix.

Turning to FIG. 8, a tracking and monitoring system 700 relying on a simplified beacon 780 is depicted in accordance with some embodiments of the present invention. Tracking and monitoring system 700 includes only a single simplified beacon 780 in communication with a subject device 720 (e.g., a monitoring bracelet). Subject device 720 is similar to or in some instances can be considered identical to a bracelet monitor 920 of FIG. 7. Also, similar to bracelet monitor 920, subject device 720 is capable of receiving GPS information from GPS satellites 745, 746, and 747 respectively. A GPS receiver 722 within subject device 720 at times is useful for determining physical locations, i.e. whenever GPS receiver 722 is powered-on, and also as long as receiving sufficient GPS satellites signal transmissions.

Tracking and monitoring system 700 illustrates subject device's 720 device ID 721 being stored in a memory 725, and is thus accessible by a controller 727. Controller 727 is able to interact with GPS receiver 722 and memory 725 at times for storing and generating records of successively determined GPS locations. Controller 727 may be, but is not limited to, a microprocessor, microcontroller or other device known in the art that is capable of executing software or firmware instructions.

Controller 727 of subject device 720 at times functions in conjunction with a cellular transceiver 728 to send and receive data and signals through cellular communication system 750. This link at times is useful for passing information and/or control signals between central monitoring system 760 and subject device 720. Cellular communication system 750 and cellular transceiver 728 can also at times often be useful for determining a physical location for subject devices 720 through AFLT when requested.

Tracking and monitoring system 700 depicts controller 727 receiving beacon information via a beacon transceiver 734. A status monitor 726, a user interface 723, a speaker/buzzer 724, and a touch sensor 742 are all interconnected and interact through controller 727. Touch sensor 742 is operable to turn off speaker/buzzer 724 when subject device is grabbed by an individual. In one case, touch sensor 742 is a button that may be depressed by an individual. In other cases, touch sensor 742 is a capacitive sensor that is triggered when a human comes into contact with subject device 720. Status monitor 726 includes one or more of the following subcomponents: a set of shielding sensors 729 that are capable of determining whether subject device is being shielded from receiving GPS signals and/or if GPS jamming is ongoing, a set of device health indicators 730, a tamper sensor 731 capable of determining whether unauthorized access to subject device 720 has occurred or whether subject device 720 has been removed from an associated human subject, a motion/proximity sensor 732 capable of determining whether subject device 720 is moving, and/or other body sensors 733 for making physical measurements of human subject 910. Based on the disclosure provided herein, one of ordinary skill in the art will recognize a variety of shielding sensors, a variety of device health transducers and indicators, a variety of tamper sensors, various different types of motion sensors, different proximity to human sensors, and various human body physical measurement sensors or transducers that may be incorporated into subject device 720 according to various different instances and/or embodiments of the present invention.

Beacon 780 includes a local transmitter 783 capable of providing information to subject device 720. Beacon 780 further includes a device ID 781 maintained in a memory 785. In some cases, memory may be a semiconductor device capable of storing information, while in other cases, memory 385 may simply be a hardwired device ID. Device ID 781 uniquely identifies beacon 780, and may in some cases be used to designate an operational difference between beacons (e.g., a beacon used to provide location information to a subject device or a beacon used to find a misplaced or discarded subject device). Beacon 780 may further include a user interface 782 that provides some indication of the operational status of the beacon. In one case, user interface 782 is a single LED indicating whether or not beacon 780 is operational.

Beacon 780 may also include a status monitor 786 that is capable of accessing information about the status of a power source 792, accessing information from a status sensor 790 indicating whether the case of beacon 780 has been tampered with, and a motion sensor 791 capable of detecting whether beacon 780 is being moved from its known location.

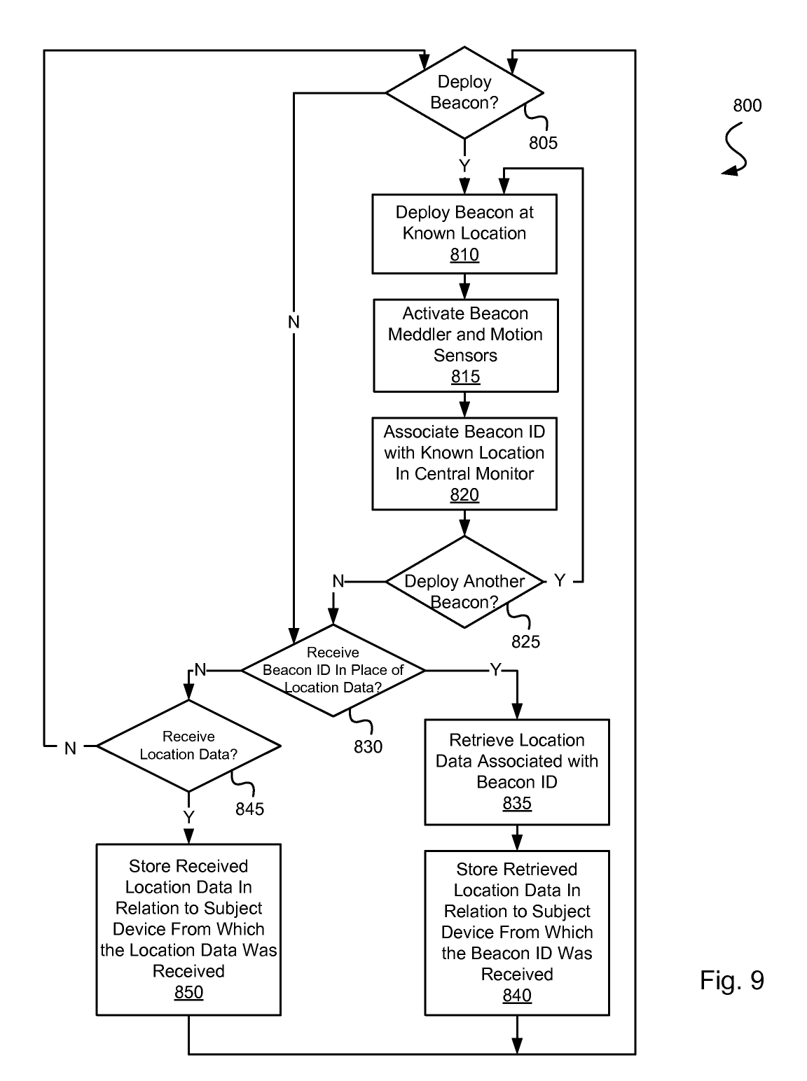

Turning to FIG. 9 a flow diagram 800 illustrates an operational process of receiving beacon based information in place of location data in accordance with some embodiments of the present invention. Following flow diagram 800, it is determined whether a beacon is to be deployed (805). Where a beacon is to be deployed (block 805), the beacon is placed at a known location where it is enabled for operation (block 810). This enabling process may include powering the beacon on and enabling the motion and tamper sensors associated with the beacon (block 815). The ID of the deployed beacon is associated with the location at where the beacon was placed (block 820). This may be done by programming the location information along with the beacon ID into central monitoring system 960. It is then determined whether another beacon is to be deployed (block 825). Where another beacon is to be deployed (block 825), the processes of blocks 810-820 are repeated for the next beacon.

Alternatively, where there are not any more beacons to deploy (block 825), the central monitoring system goes about monitoring locations using the available beacon information. In particular, when the central monitoring system receives information from a subject device it is determined whether the received information includes a beacon ID in place of location data (block 830). Where a beacon ID is not received (block 830), it is determined whether the received information includes location information (block 845). Where location information is received (block 845), the received location information is stored in relation to the subject device that provided the information (block 850), and the process is repeated. Otherwise, where location information is not received (block 845), the process is simply repeated.

Alternatively, where a beacon ID is received (block 830), the location associated with the received beacon ID is retrieved (block 835). The retrieve location information is then stored in relation to the he subject device that provided the information (block 840). Once complete, the process is repeated.

In conclusion, the present invention provides for novel systems, devices, and methods for monitoring and tracking. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for locating an individual monitoring device, wherein the method comprises:
determining a discard status of an individual monitoring device;
identifying a location of the individual monitoring device;
uploading the location of the individual monitoring device to a monitoring system via a wireless communication link;
entering a low power state of the individual monitoring device;
receiving a wake-up signal from a mobile transmitter; and
transmitting a human identifiable location signal.

2. The method of claim 1, wherein determining the discard status includes identifying one or more status selected from a group consisting of:
an indication of no motion from a motion sensor;
an indication from a continuity sensor that the individual monitoring device was removed; and
an indication from a proximity sensor that the individual monitoring device has been moved out of range of a monitored subject.

3. The method of claim 1, wherein the discard status includes identifying a combination of: an indication of no motion from a motion sensor, an indication from a continuity sensor that the individual monitoring device was removed, and an indication from a proximity sensor that the individual monitoring device has been moved out of range of a monitored subject.

4. The method of claim 1, wherein identifying the location of the individual monitoring device includes obtaining a location fix selected from a group consisting of: a GPS fix and an AFLT fix.

5. The method of claim 1, wherein entering the low power state includes turning off a location fix system and a transmission system of the individual monitoring device.

6. The method of claim 1, wherein entering the low power state includes turning off all systems of the individual monitoring device except a wake-up receiver.

7. The method of claim 1, wherein the human identifiable signal includes an audible signal.

8. The method of claim 7, wherein the human identifiable signal further includes a visual signal.

9. An individual monitoring device, wherein the individual monitoring device comprises:
a beacon based location fix system;
a GPS based location fix system;
an earth based location fix system; and
a location fix selector, wherein the location fix selector is operable to select a location fix from one of the beacon based location fix system, the GPS based fix system, and the earth based location fix system.

10. The individual monitoring device of claim 9, wherein the beacon based location system includes:
a receiver tailored to receive the location of a fixed beacon via a wireless transmission link and to store the location of the fixed beacon as a location of the individual monitoring device.

11. The individual monitoring device of claim 9, wherein the individual monitoring device further comprises:
a transmitter, wherein the transmitter is operable to wirelessly transmit the location fix to a monitoring system via a wireless communication link.

12. The individual monitoring device of claim 9, wherein the individual monitoring device further comprises:
a location fix tamper detector, wherein the location fix tamper detector is selected from a group consisting of: a shield detector and a GPS jamming detector.

13. The individual monitoring device of claim 9, wherein the individual monitoring device further comprises:
a discard detector, wherein the discard detector is operable to identify a discard status selected from a group consisting of:
an indication of no motion from a motion sensor;
an indication from a continuity sensor that the individual monitoring device was removed; and
an indication from a proximity sensor that the individual monitoring device has been moved out of range of a monitored subject.

14. The individual monitoring system of claim 13, wherein the individual monitoring device further comprises:
a recovery system, wherein the recovery system includes a receiver operable to receive and identify a signal from a mobile transmitter and to sound an audible recovery signal.

15. The individual monitoring system of claim 14, wherein the recovery system is activated when at least one discard status indicator is received, wherein the at least one status indicator is selected from a group consisting of: the indication of no motion, the indication from a continuity sensor that the individual monitoring device was removed, or the indication from the proximity sensor that the individual monitoring device has been moved out of range of the monitored subject; and wherein the recovery system is operable to transition the individual monitoring device into a low power state upon receiving the discard status indicator.

16. A method for identifying a location of a monitored individual, the method comprising:
providing an individual monitoring device, wherein the individual monitoring device includes: a beacon based location fix system, a GPS based location fix system, and an earth based location fix system;
determining at least one available location method; and
selecting and performing a preferred location method.

17. The method of claim 16, wherein determining the at least one available location method includes determining through use of the beacon based location fix system that a location beacon is in range, and wherein selecting and performing the preferred location method includes receiving the location of the location beacon as the location of the monitored individual.

18. The method of claim 16, wherein determining the at least one available location method includes determining through use of the beacon based location fix system that a location beacon is not in range and through use of the GPS based location fix system that GPS is available, and wherein selecting and performing the preferred location method includes receiving GPS location as the location of the monitored individual.

19. The method of claim 16, wherein determining the at least one available location method includes determining through use of the beacon based location fix system that a location beacon is not in range, through use of the GPS based location fix system that GPS is not available, and wherein selecting and performing the preferred location method includes performing an AFLT fix using the earth based location fix system.

20. The method of claim 16, wherein the method further comprises:
performing a confidence analysis of a location of the monitored individual.
